(19) United States
(12) Patent Application Publication
(10) Pub. No.: US 2008/0216460 A1
(43) Pub. Date: Sep. 11, 2008

(54) GRAIN LIFTER

(76) Inventor: Edmund A. Pawluski, Eaglesham (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/685,694

(22) Filed: Mar. 13, 2007

(30) Foreign Application Priority Data
Mar. 5, 2007 (CA) 2581024

(51) Int. Cl. A01D 46/00

(52) U.S. Cl. 56/13.2

(57) ABSTRACT

A grain lifter may be attached to the front end of a tractor or dozer. The grain lifter has an auger for moving grain or other bulk commodities towards a receiving end of the auger. A support structure supports the auger and has at least a vertical collecting wall and a collecting lip which lies under the auger to help collect grain as the grain lifter is moved through a pile of grain. The auger is enclosed on two sides by the collecting wall and collecting lip. A collection device lies adjacent the receiving end of the auger to collect grain that is directed to that end of the auger. In a method for using the grain lifter, a grain pile is collected. A tractor having a grain lifter is driven into the grain pile. Grain is moved along the length of the auger towards the collection device. The grain is then collected through the collection device. The collecting device may be a vacuum pump.

### BACKGROUND

In farming, a grain pile is often used to store large quantities of grain before it is transported to a distribution point. To prevent bacteria and other contaminants from the ground being introduced into the grain it is beneficial to avoid placing grain collections directly on open ground. In some cases asphalt is placed on the ground prior to forming a grain pile. However, due to the high expense of laying asphalt, this option is not economically viable for most farmers. A less expensive option is to lay sheets of plastic over the ground on which the grain pile is placed to separate the grain from the open ground. However, many common techniques of removing grain from a grain pile would cause many tears in the plastic, thereby exposing the grain to the open ground and preventing the plastic from being reused.

Also, many common techniques of removing grain from a grain pile require difficult manual labor to fully remove the grain. Due to difficulties in removing grain completely from the grain pile with commonly used equipment, alternative methods to remove leftover grain may be required. For example, in some cases a person may have to remove leftover grain manually with a shovel. Also, often grain removal equipment, for example vacuum pumps, may need to be manually maneuvered to remove grain, which may be time consuming and physically demanding work.

### SUMMARY

The grain lifter addresses these and other difficulties with the prior art.

In one embodiment of a grain lifter for collecting grain there is an auger having a length for moving grain towards a receiving end of the auger. A support structure having a collecting wall and collecting lip supports the auger and extends the length of the auger. The collecting wall extends vertically along the length of the auger and the collecting lip lies under the auger along the length of the auger. A collection device is connected to the support structure adjacent to the receiving end of the auger and is positioned so that grain moved along the length of the auger is collected by the collection device.

In one embodiment, there is a method of collecting grain comprising the steps of firstly collecting a grain pile. Secondly, driving a tractor having an auger, a support structure and a collection device attached to the front end of the tractor into the grain pile. The auger and the collection device lie on the support structure and are positioned so that the auger directs grain towards the collection device. Thirdly, moving grain in the grain pile along the auger towards the collection device. And lastly, collecting the grain from the pile through the collection device.

In one embodiment there is a grain lifter for collecting grain in combination with a tractor having a width, the grain lifter comprising an auger having a length for moving grain towards a receiving end of the auger. A support structure supports the auger and extends the length of the auger, and a collection device is connected to the support structure adjacent to the receiving end of the auger and is positioned so that grain moved along the length of the auger is collected by the collection device. The support structure is attached to the front end of the tractor and extends across the full width of the tractor.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of an embodiment of the grain lifter mounted on a tractor while in operation;

FIG. 2 is a front perspective view of an embodiment of the grain lifter mounted on a tractor;

FIG. 3 is a perspective view of a grain pile;

FIG. 4 is a top plan view of an embodiment of the grain lifter in operation with a tractor and collecting vehicle;

FIG. 5 is a first perspective side view of an embodiment of the grain lifter;

FIG. 6 is a second perspective side view of an embodiment of the grain lifter;

FIG. 7 is a back perspective view of an embodiment of the grain lifter;

FIG. 8 is a top perspective view of an embodiment of the grain lifter;

FIG. 8A is a partial sectional view of the grain lifter taken along the section A-A of FIG. 8.

### DETAILED DESCRIPTION

In the claims, the word “comprising” is used in its inclusive sense and does not exclude other elements being present. The indefinite article “a” before a claim feature does not exclude more than one of the feature being present.

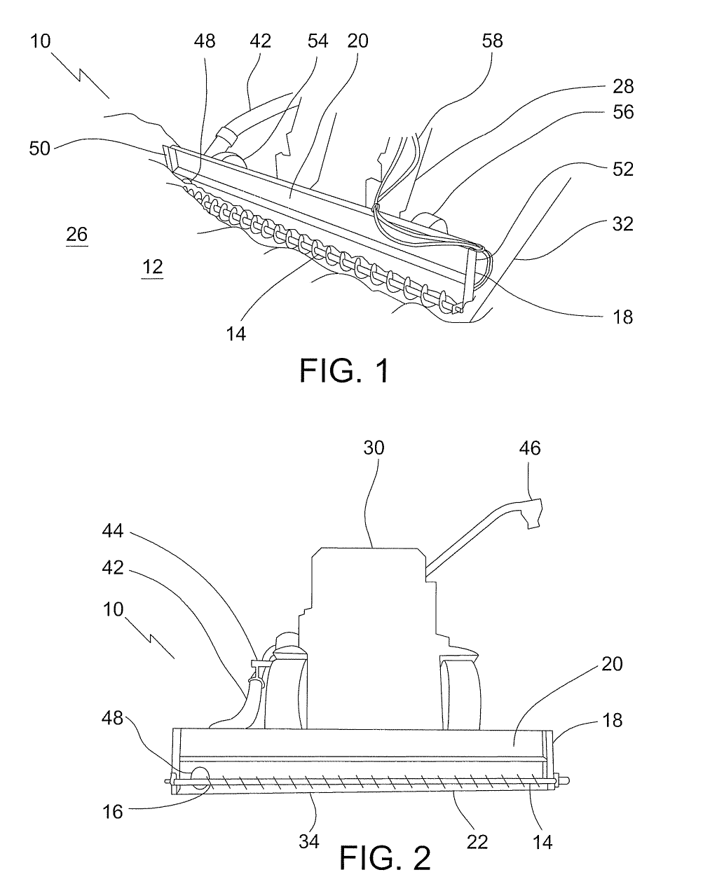

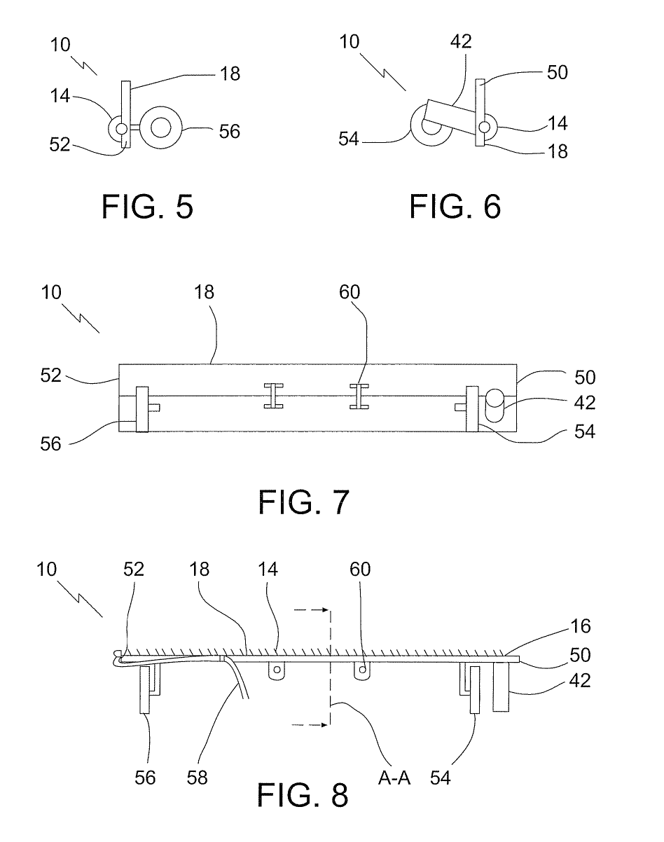

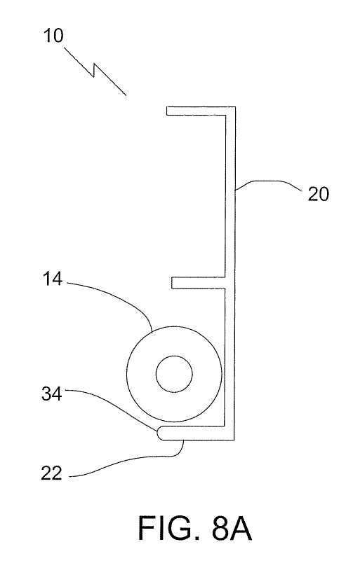

An embodiment of the grain lifter 10 for collecting grain 12 is shown in FIGS. 1-8A. The grain lifter 10 has an auger 14 for moving grain 12 towards a receiving end 16 of the auger 14. The auger 14 has a length defined by the axis of rotation of the auger 14. A support structure 18 supports the auger 14 and extends along the length of the auger 14. The support structure 18 has at least a collecting wall 20 and a collecting lip 22. The collecting wall 20 extends vertically along the length of the auger 14 and the collecting lip 22 lies under the auger 14 along the length of the auger 14. A collection device 24 is connected to the support structure 18 adjacent to the receiving end 16 of the auger 14 and positioned so that the grain 12 moving along the length of the auger 14 is collected by the collection device 24.

The grain lifter 10 may be attached to the front end loader 28 of a vehicle, such as a tractor 30. Alternatively, the grain lifter 10 may be attached to a dozer frame. In the embodiment shown the collection device 24 is a vacuum pump. The collecting lip 22 in the embodiment shown has a rounded edge 34 that allows the grain lifter 10 to advance across the ground without tearing the ground. A vacuum hose 42 attaches to the back end of the grain lifter 10 adjacent to the receiving end 16 of the auger 14. A grain collecting opening 48 allows grain 12 to be collected through the grain collecting opening 48 into the vacuum hose 42. A vacuum hose support 44 is used to support the vacuum hose 42 above the ground; however, in other embodiments the vacuum hose support 44 may not be necessary. Two support wheels 54, 56 lie on opposite ends 50, 52 of the support structure 18. Hydraulic power conduits 58 attach to tractor hydraulics (not shown) and provide power for the auger 14. The support structure 18 extends across the full width of the tractor 30 allowing the tractor 30 to drive through a grain pile 26. In the embodiment shown, the support structure 18 extends further beyond a first end of the tractor 30 corresponding to the first end 50 of the support structure 18 than to a second end of the tractor 30 corresponding to the second end 52 of the support structure 18. The first end 50 of the support structure 18 is the end of the support structure 18 adjacent to the receiving end 16 of the auger 14. The support structure 18 has a front end on which the auger 14 is supported and a back end opposite the auger 14. On the back end of the support structure 18 are flanges 60 that are welded to the collecting wall 20 so that the front end loader 28 or dozer frame can be fitted with the grain lifter 10.

In operation, the grain lifter 10 is driven into the grain pile 26 or other collection of grain or bulk commodity. The collecting lip 22 ensures that almost all of the grain is collected by the grain lifter 10 as the grain lifter 10 is driven forwards. As the grain lifter 10 advances through the grain, the grain 12 collects against the collecting wall 20. The auger 14 pushes the collected grain towards the receiving end 16 of the auger 14, where it is pulled through the grain collecting opening 48 by the vacuum pump 24. The grain 12 is pulled through the vacuum hose 42 and towards the vacuum pump 24. The vacuum pump 24 may be towed behind the tractor 30 in a trailer 36. Alternatively the vacuum pump 24 may be a stand alone unit with wheels that may be towed behind the tractor 30 without the trailer 36. Any means of collecting the grain 12 from the vacuum pump 24 may be used. In the embodiment shown the grain 12 is expelled from the vacuum pump 24 through a grain discharge attachment 46 into a collecting vehicle 38. The collecting vehicle 38 is then able to transport the grain 12 to any convenient location.

The grain lifter 10 may be advanced through the grain pile 26 or collection of grain in discrete steps. First, the grain lifter 10 may be advanced forward into the collection of grain until the grain 12 collects against the collecting wall 20 and then the grain lifter 10 can operate in a single position until all the grain is collected from that location. As the auger 14 and collection device 24 operate, the grain level will decrease and grain lying forward and above the collecting wall 20 will fall under the force of gravity towards the grain lifter 10. Eventually, enough grain will be collected to allow the grain pile 26 to stabilize so that grain ceases falling towards the grain lifter 10. At this time, the grain lifter 10 may again be advanced forward into the grain pile 26 and the grain 12 may be collected again in the same way by allowing grain to collect against the collecting wall 20 and then removing the grain as it collects.

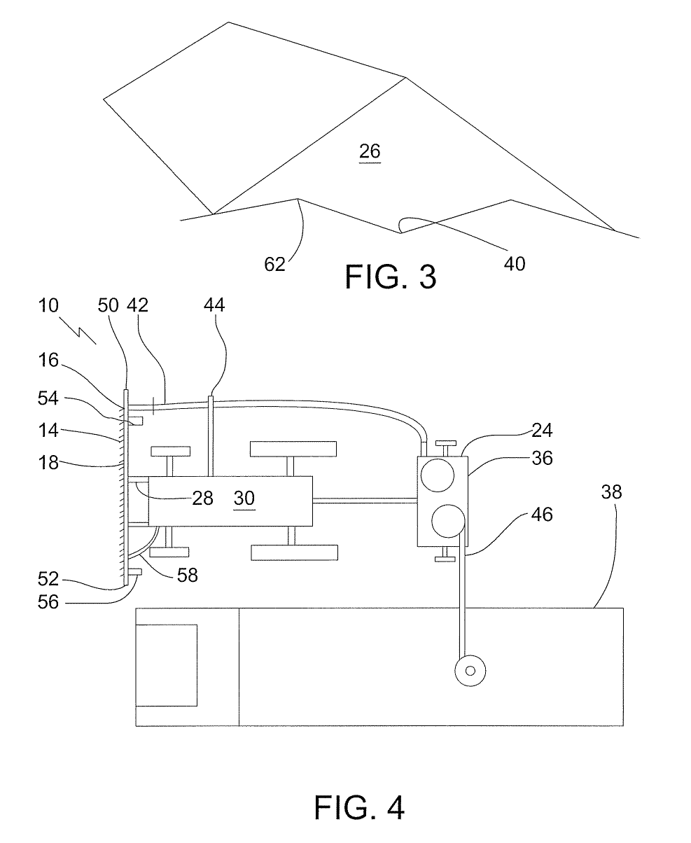

Grain piles 26 exist in a variety of shapes and orientations, for example, grain piles may lie in long rows as shown in FIG. 3. In the case where grain piles lie in long rows, it may be advantageous to advance the grain lifter 10 parallel through the row along the perimeter of the grain pile 26 with the grain collecting opening 48 located closer to the apex of the grain pile 26 than the opposite end of the grain lifter 10. By removing grain 12 from the perimeter, the grain will collect into the grain collecting opening 48 and will function to move the apex of the grain pile 26 away from the end along which collection was performed. Removing grain consistently from one end allows for a systematic removal of the grain pile 26.

When collecting grain 12 or creating a grain pile 26, it may be desired to ensure proper water drainage away from the collection of grain and to lay down plastic beneath the collection of grain. One method of ensuring proper drainage is to create minimally inclined pyramid-shaped mounds 62 on the ground. As shown in FIG. 3, the pyramid-shaped mounds 62 create draining channels 40 between them that allow for water to drain away from the grain pile 26. Additionally or alternatively, a sheet of plastic 32 may be placed over the ground before the grain pile 26 is created. The grain lifter 10 may operate on top of the sheet of plastic 32 without excessive tearing of the plastic.

As an example only and not limiting the scope of this patent document some possible components of the grain lifter 10 will now be described. The collecting wall 20 may be constructed with two 12 inch channel irons welder together. The auger 14 may be a 6 inch screw conveyor that is mounted to the bottom of the front of the two 12 inch channel irons. A 7 inch pipe may be used as the grain collecting opening 48 and may be welded on an upward angle at the receiving end 16 of the auger 14. The flanges 60 may be ¾3 inch flat iron. The vacuum hose may weigh approximately 40 to 50 pounds and the vacuum hose support 44 may be constructed with square tubular steel and have a spring that attaches to a mount on the hose. The vacuum pump 24 may be a Grain Vac™ pump.

Although a vacuum pump is the only method disclosed herein of collecting the grain that is dispensed from the grain lifter 10, alternative methods may also be used. For example, a second auger or conveyor system may be able to perform the same role as the vacuum pump. The grain lifter 10 is designed particularly for cereal grain but may also be used for other bulk commodities.

These and other immaterial modifications may be made to the embodiments described here without departing from what is covered by the claims.

The embodiments of the invention in which an exclusive property or privilege is claimed are defined as follows:

1. A grain lifter for collecting grain, comprising:
an auger for moving grain towards a receiving end of the auger, the auger having a length;
a support structure supporting the auger and extending the length of the auger, the structure having at least a collecting wall and a collecting lip, the collecting wall extending vertically along the length of the auger and the collecting lip lying under the auger along the length of the auger;
a collection device being connected to the support structure adjacent to the receiving end of the auger and positioned so that grain moved along the length of the auger is collected by the collection device.

2. The grain lifter of claim 1 in which the collection device comprises a vacuum pump.

3. The grain lifter of claim 2 in which the support structure is supported on the front end of a tractor when in operation.

4. The grain lifter of claim 1 in which the collecting lip has a rounded edge lying opposed to the collecting wall.

5. The grain lifter of claim 1 in which the collecting wall extends vertically above the auger.

6. The grain lifter of claim 3 in which the vacuum pump is pulled in a trailer behind the tractor.

7. The grain lifter of claim 6 in which the vacuum pump expels grain collected from the auger into a separate collection vehicle.

8. The grain lifter of claim 1 in which the support structure has two ends, a first end adjacent to the receiving end of the auger and a second end lying on the opposite end of the length of the auger to the receiving end of the auger, and further comprising:
a first supporting wheel attached to the first end of the support structure; and
a second supporting wheel attached to the second end of the support structure.

9. A method of collecting grain, comprising:
collecting a grain pile;
driving a tractor into the grain pile, the tractor having an auger, a support structure and collection device attached to the front end of the tractor, the auger and collection device lying on the support structure and positioned so that the auger directs grain towards the collection device;
moving grain in the grain pile along the auger towards the collection device; and
collecting the grain from the pile through the collection device.

10. The method of collecting grain of claim 9 further comprising laying down at least one sheet of plastic prior to the step of collecting the prior of grain.

11. The method of collecting grain of claim 10 further comprising removing the at least one sheet of plastic after the step of collecting the grain from the pile through the collection device.

12. The method of collecting grain of claim 9 in which the collection device comprises a vacuum pump.

13. The method of collecting grain of claim 12 further comprising pulling the vacuum pump in a trailer behind the tractor.

14. The method of collecting grain of claim 13 further comprising depositing the grain collected through the vacuum pump into a separate collection vehicle.

15. The method of collecting grain of claim 10 further comprising shaping the ground with draining channels prior to the step of laying down at least one sheet of plastic

16. A grain lifter for collecting grain in combination with a tractor having a width, comprising:
an auger for moving grain towards a receiving end of the auger, the auger having a length;
a support structure supporting the auger and extending the length of the auger;
a collection device being connected to the support structure adjacent to the receiving end of the auger and positioned so that grain moved along the length of the auger is collected by the collection device; and
in which the support structure is attached to the front end of the tractor and extends across the full width of the tractor.

17. The grain lifter of claim 16 in which the tractor has a first side having the collection device and a second side and in which the support structure extends further beyond the first side of tractor than the second side of the tractor.

18. The grain lifter of claim 16 in which the collection device further comprises:
a collecting wall extending along the length of the auger; and
a collecting lip lying under the auger and extending along the length of the auger.

19. The grain lifter of claim 18 in which the collecting lip further comprises a rounded edge lying opposite to the collecting wall.
